(19) United States
(12) Patent Application Publication
(10) Pub. No.: US 2004/0137192 A1
(43) Pub. Date: Jul. 15, 2004

(54) Injection molded fastening article for use as a mold insert

(76) Inventor: Henry J. McVicker, Naples, FL (US)

Correspondence Address: JONES DAY, 77 WEST WACKER, CHICAGO, IL, 60601-1692, US

(21) Appl. No.: 10/745,367

(22) Filed: Dec. 23, 2003

Related U.S. Application Data
(60) Provisional application No. 60/436,035, filed on Dec. 23, 2002.

(51) Int. Cl. B32B 3/06

(52) U.S. Cl. 428/100; 24/442

(57) ABSTRACT

An injection molded insert having a field of integrally formed hooks on a surface can be used as a component of a molded article, such that the field of hooks will be on a surface of the molded article. The molded article having the mold insert as a component can be formed by various molding processes such as injection molding, compression molding, blow molding or rotational molding, or by forming from a moldable mass such as sprayable resins, epoxy-based resins, or fiberglass-based resins.

This application claims the benefit of provisional patent application Serial No. 60/436,035, filed Dec. 23, 2002, under 35 U.S.C. § 119.

### BACKGROUND OF THE INVENTION

This invention relates to a method of molding an article with a field of hook elements in at least one surface thereof, and a mold insert for use in such a method.

Fastening elements are known in the prior art in a variety of different formats, including releasable fastening systems such as snaps, buttons, and hooks, and non-releasable fastening systems such as rivets, screws and nails. One releasable fastening system, originated by the Velcro Company, uses mating surfaces of hooks and loops. In a Velcro-type system, one flexible ribbon is provided with a field of tiny flexible hooks on one surface thereof, and a mating flexible ribbon is provided with a field of loops on one surface thereof. The hook-bearing ribbon and the loop-bearing ribbon are attached to surfaces of objects to be fastened together. The objects can be releasably attached to one another by pressing the hook-bearing surface on one object and the loop-bearing surface on the other object against each other, such that the hooks and the loops releasably engage one another. The hook- and loop-bearing ribbons can be sewn to fabric, or can be glued to rigid surfaces.

Ribbon-backed hook and loop type fasteners are used in a variety of manufactured articles, including apparel, sport pads, back packs, and the like. In such articles, the hook and loop fasteners are stitched into a fabric portion of the article, or are secured by other means such as adhesives. Thus the hook portion of the article must be separately manufactured and then applied to the article. These steps are time consuming and require additional labor and other associated costs.

Much effort has been devoted to finding a way to incorporate a fastening element in a plastic molded article during the molding process. In particular, such efforts have been directed at the manufacture of automobile seats in the attachment of a seat cover to a polyurethane foam bun with a molded-in hook-type fastening element. U.S. Pat. Nos. 5,540,970, 5,736,217, and 5,922,436, and the prior art discussed therein exemplify the challenges faced by those trying to develop such a process. In such processes, problems can arise if the field of hooks is contaminated by the foam of the seat cushion. To avoid that problem, a cover film over the field of hooks has been necessary. According to the aforementioned patents, such cover films are light and flimsy, thus limiting the degree of protection offered to the hooks against the high temperatures and pressures that can occur during various molding processes. It is stated therein that such devices cannot be used to mold hooks into hard plastic using a standard injection molding machine where the high temperature of the molten plastic has a tendency to melt the hooks, or the high pressure of the plastic is capable of crushing the hooks. The aforementioned patents propose a method wherein extruded plastic hook fastening elements are molded into an injection molded or compression molded article by first encasing the hook field in a removable elastomeric composition that fills the volume surrounding at least some of the hook elements.

U.S. Pat. No. 4,842,916 and U.S. Pat. No. 4,931,344 to Ogawa et al. disclose a fastening component having hook like interlocking elements on the front side of a substrate sheet and an anchor member on the back side. The front surface also has at least one flat portion void of the interlocking elements to make the fastener flexible or pliable to fit into the curved or bent portion of a molded cushion body or other molded structure on which the fastener component is to be anchored. The fastener component may also be provided with side edges for mounting magnetic strips which can be used to fix the fastener component in a mold during a molding process.

U.S. Pat. No. 5,286,431, U.S. Pat. No. 5,540,970, U.S. Pat. No. 5,736,217 and U.S. Pat. No. 5,922,426, all assigned to Velcro Industries B.V., disclose a fastener of the hook and loop type intended to be incorporated into plastic articles by plastic molding processes, formed of a known separable fastener member having a base member and a plurality of engaging elements upstanding from one surface. A covering intimately surrounds the engaging elements to protect them from the harsh environment of the molding process. The covering is removable from the fastener after the molding process to expose the engaging elements without permanently deforming or substantially destroying the fastening performance thereof.

U.S. Pat. No. 5,368,549, U.S. Pat. No. 5,656,226, and U.S. Re. No. 37,338, each of which is incorporated herein by reference in its entirety, disclose an injection molded article having a field of injection molded hooks integrally molded into one substantially rigid wall of the article, and a method of making such an injection molded article with a field of integrally molded hooks. In the embodiment disclosed in those patents, the article is an orthopedic ankle brace, which is fastened about the ankle of a user by means of a loop-bearing strap that is attached to one portion of the brace and releasably attaches to the injection molded field of hooks.

EPO 0 464 755 assigned to YKK company discloses a fastening element having a field of hooks on one side that is used to retain a fabric covering against the inside surface of a car roof, and a fastening clip molded to the opposite side to hold the fastening element in place.

U.S. Pat. No. 6,463,635 to Murasaki discloses a surface fastener having fields of hooks on one surface thereof, the peripheries of the fields being blocked by fence portions made of foam members bonded to the surface of the flat base portion from which the fields of hooks extend. The fence prevents foam from penetrating the fields of hooks when the fastener is embedded in a seat cushion molded of foam resin.

It is an object of the invention to provide a method of molding an article using a mold insert having a field of hook elements on at least one surface thereof.

It is yet another object of the invention to provide hook bearing mold insert for use in such a method.

### SUMMARY OF THE INVENTION

In accordance with the method of the invention, a mold insert is provided, the mold insert being an article having a field of integrally formed hooks on at least a first surface thereof, and having a second surface opposite the first surface. The insert is then fitted into a recess in a mold of the desired final article, with the first surface having the field of hooks thereon facing the mold exterior and the second surface of the mold insert facing the mold interior. The molding process is then carried out. The plastic of the resulting molded article surrounds the second surface of the mold insert, such that the mold insert becomes integral with the resultant molded article. Preferably, the hooks on the first surface of the mold insert are protected from the heat and pressure of the molding process by the structure of the mold insert. The molding process by which the resultant molded article is made can be injection molding, compression molding, rotational molding, blow molding, foam molding and other known molding techniques. The instant invention is also applicable to molding processes in which a molding material is dispersed inside a mold by means such as a spray gun or a trowel, as in the manufacture of fiberglass articles.

### DESCRIPTION OF THE FIGURES

FIG. 1 is a front elevation view of one embodiment of a mold insert to be used in a subsequent manufactured article.

FIG. 2 is a side cross section view taken through line 2-2 of FIG. 1 after the insert has been molded into a manufactured article.

FIG. 3 is a front elevation view of another embodiment of a mold insert to be used in a subsequent manufactured article.

FIG. 4 is a side cross section view taken through line 4-4 of FIG. 3 after the insert has been molded into a manufactured article.

FIG. 5 is a side cross section view of yet another embodiment of a mold insert to be used in a subsequent manufactured article.

FIG. 6 is a front elevation view of yet another embodiment of a mold insert to be used in a subsequent manufactured article.

FIG. 7 is a front elevation view of still another embodiment of a mold insert to be used in a subsequent manufactured article.

### DETAILED DESCRIPTION OF THE INVENTION

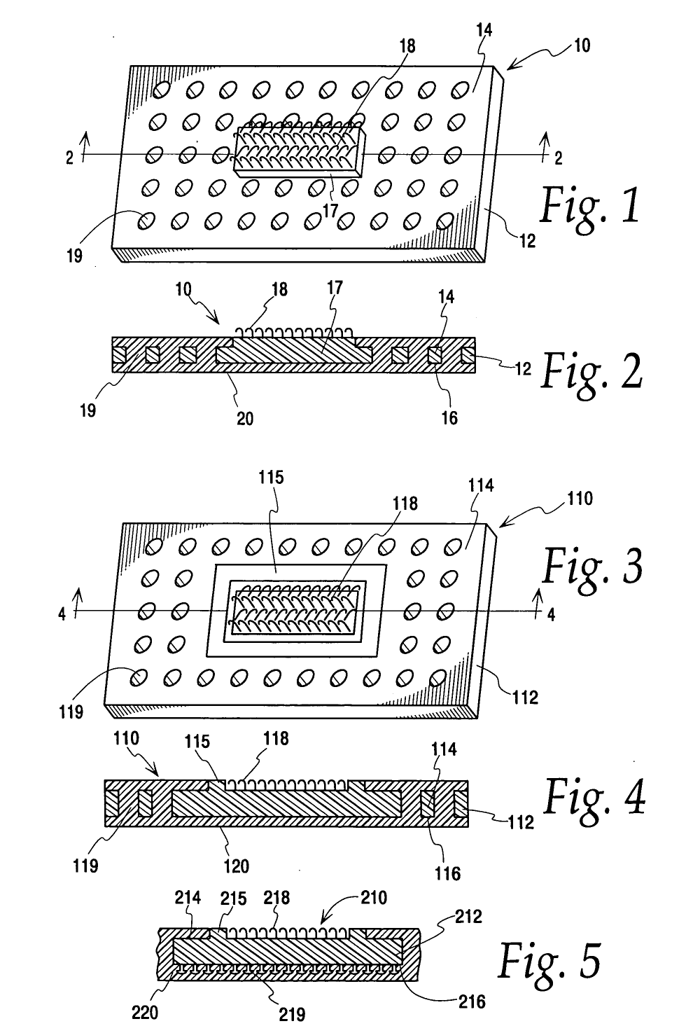

FIGS. 1 and 2 illustrate one embodiment of a mold insert being a molded fastening element having a field of hooks thereon such as is suitable for use as a component of a hook and loop fastening system. In the illustrated embodiment, insert 10 comprises a wall member 12 having an outer-facing surface 14 and an inner-facing surface 16. Disposed on outer surface 14 is a plateau 17, on the upper surface of which is a field of hooks 18. Field of hooks 18 can be of any desired shape and size. The hooks can be single tipped hooks or double tipped hooks. The hooks can be facing all in one direction, or in alternating directions, or in any arrangement of directions that meets the needs of a particular application. In the illustrated embodiment, wall 12 can be provided with a plurality of holes 19.

Insert 10 can be placed in a recess in a molding machine as is well-known in the molding arts, such that inner-facing surface 16 faces the inside of the mold cavity, and outer-facing surface 14 with plateau 17 and field of hooks 18 faces the outside of the mold cavity. FIG. 2 illustrates the embodiment of FIG. 1 when it has been molded into a manufactured article comprising a plastic material 20. It may be seen that the during the manufacturing process the plastic material 20 has completely surrounded inner surface 16, and has flowed through the plurality of holes 19 to completely cover outer surface 14, except for plateau 17 and field of hooks 18. The plastic 20 flows through holes 19 and envelops wall member 12 to provide secure engagement of insert 10 in the manufactured article, such that insert 10 becomes an integral part thereof. Field of hooks 18 will be on the outer surface of the molded article to be able to engage a corresponding loop bearing member.

FIG. 3 illustrates an alternative embodiment of a mold insert for use in the instant invention.

In the illustrated embodiment, insert 110 comprises a wall member 112 having an outer-facing surface 114 and an inner-facing surface 116. Disposed on outer surface 114 is a field of hooks 118, surrounded by ridge 115. Field of hooks 118 can be of any desired shape and size. The hooks can be single tipped hooks or double tipped hooks. The hooks can be facing all in one direction, or in alternating directions, or in any arrangement of directions that meets the needs of a particular application. In the illustrated embodiment, wall 112 can be provided with a plurality of holes 119.

Insert 110 can be placed in a recess in a molding machine as is well-known in the molding arts, such that inner-facing surface 116 faces the inside of the mold cavity, and outer-facing surface 114 with ridge 115 and field of hooks 118 faces the outside of the mold cavity. FIG. 4 illustrates the embodiment of FIG. 3 when it has been molded into a manufactured article comprising a plastic material 120. It may be seen that the during the manufacturing process the plastic material 120 has completely surrounded inner surface 116, and has flowed through the plurality of holes 119 to completely cover outer surface 114, except that ridge 115 has served as a dam to protect field of hooks 118 from the flow of plastic 120. The plastic 120 flows through holes 119 and envelops wall member 112 to provide secure engagement of insert 110 in the manufactured article, such that insert 110 becomes an integral part thereof. Field of hooks 118 will be on the outer surface of the molded article to be able to engage a corresponding loop bearing member.

FIG. 5 illustrates yet another embodiment of the instant invention. In this embodiment, insert 210 comprises a wall member 212 having an outer-facing surface 214 and an inner-facing surface 216. Disposed on outer-facing surface 214 is a field of hooks 218, surrounded by ridge 215. Disposed on inner-facing surface 216 is a field of projections 219. Although shown in the form of hermaphroditic mushroom shaped protrusions, it will be understood that protrusions 219 can be configured as hooks, palm trees, or other shapes known in the fastening art. The protrusions 219 serve to provide a mating surface for flowing plastic 220, to securely engage insert 210 in the manufactured article. It will be appreciated that while the embodiment of FIG. 5 could be more complicated to manufacture, it allows for mold insert 210 to use a smaller wall member 212 than the embodiments of FIGS. 1 and 3.

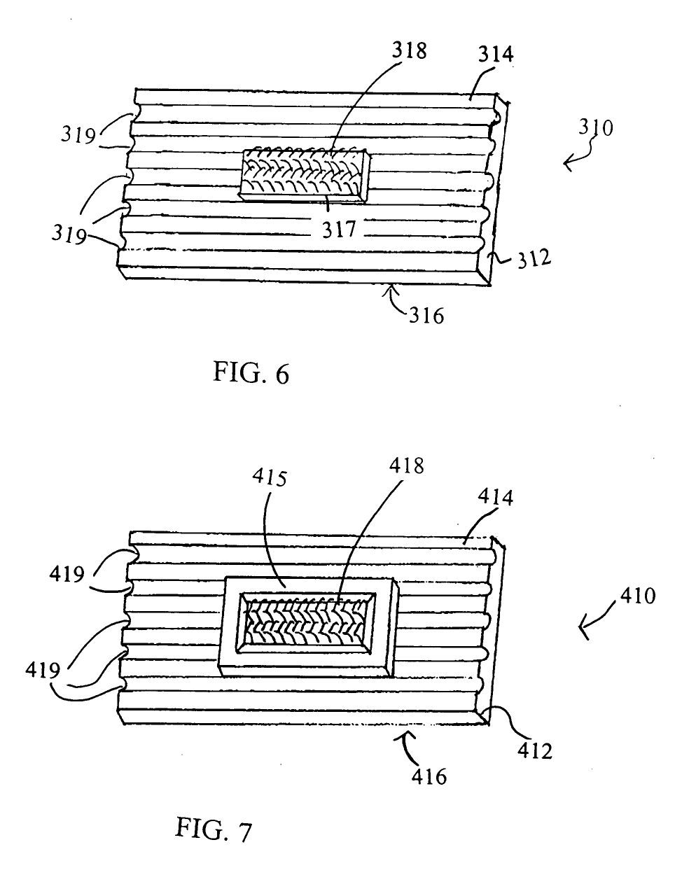

FIG. 6 illustrates an embodiment of the invention in which insert 310 comprises a wall member 312 having an outer-facing surface 314 and an inner-facing surface 316. Disposed on outer surface 314 is a plateau 317, on the upper surface of which is a field of hooks 318. Field of hooks 318 can be of any desired shape and size. The hooks can be single tipped hooks or double tipped hooks. The hooks can be facing all in one direction, or in alternating directions, or in any arrangement of directions that meets the needs of a particular application. In the illustrated embodiment, wall 312 can be provided on its outer facing surface 314 with a plurality of grooves 319 along which plastic can flow. During the subsequent manufacturing process of a molded article using mold insert 310, the plastic material can completely surround inner surface 316, and flow along the plurality of grooves 319 to completely cover outer surface 314, except for plateau 317 and field of hooks 318. The plastic flows along grooves 319 and envelops wall member 312 to provide secure engagement of insert 310 in the manufactured article, such that insert 310 becomes an integral part thereof. Field of hooks 318 will be on the outer surface of the molded article to be able to engage a corresponding loop bearing member.

FIG. 7 illustrates still another embodiment of a mold insert for use in the instant invention.

In the illustrated embodiment, insert 410 comprises a wall member 412 having an outer-facing surface 414 and an inner-facing surface 416. Disposed on outer surface 414 is a field of hooks 418, surrounded by ridge 415. Field of hooks 418 can be of any desired shape and size. The hooks can be single tipped hooks or double tipped hooks. The hooks can be facing all in one direction, or in alternating directions, or in any arrangement of directions that meets the needs of a particular application. In the illustrated embodiment, wall 412 is provided with a plurality of grooves 419.

Insert 410 can be placed in a recess in a molding machine as is well-known in the molding arts, such that inner-facing surface 416 faces the inside of the mold cavity, and outer-facing surface 414 with ridge 415 and field of hooks 418 faces the outside of the mold cavity. During the manufacturing process the plastic material can completely surround inner surface 416, and flow along the plurality of grooves 419 to completely cover outer surface 414, except that ridge 415 has served as a dam to protect field of hooks 418 from the flow of plastic. The plastic flows along grooves 419 and envelops wall member 412 to provide secure engagement of insert 410 in the manufactured article, such that insert 410 becomes an integral part thereof. Field of hooks 418 will be on the outer surface of the molded article to be able to engage a corresponding loop bearing member.

The mold insert of the instant invention with a field of hooks integrally formed on a portion thereof can be made by injection molding in accordance with the methods disclosed in the aforementioned U.S. Pat. No. 5,368,549, U.S. Pat. No. 5,656,226, and U.S. Re. No. 37,338. As disclosed therein, the hooks of the injection molded insert will have a radius and geometry that will promote the ejection of the hooks from the injection mold, while still maintaining the desired fastening function. The hooks will straighten momentarily as they are removed from the injection mold. The mold insert of the invention is molded from a thermoplastic material that has sufficient flexibility to allow the hooks to straighten during removal from the mold and during subsequent release form a field of loops, yet has a memory sufficient to return to substantially the original hook shape and geometry. A material that is too rigid or brittle would snap off during such flexing. On the other hand, a material that is too soft would lack the structural rigidity required for the hooks to function as a fastener. Suitable thermoplastic materials include polypropylene and polyurethane materials having the desired balance of flexibility and shape memory. The polypropylene can be, for example, an unfilled polyester blend of 50% homopolymer and 50% copolymer having melt flow index of 22 g/10 min. and a flex modulus from 130,000 to 150,000 psi. Another suitable polypropylene material is sold by Washington Penn Plastic Company of Washington, Pa. as product PPC3CF1, having a melt flow index of 11.6 g/10 min.; a notched Izod impact strength of 3.1 ft-lbs./in., a tensile strength of 3000 psi, and a flex modulus of 163,300 psi.

Other propylene based resins that have been found suitable for use in forming molded hooks include Atofina polypropylene PPC 5660, having a melt flow index of 7, and a flex modulus of about 175,000 psi; various resins sold under the name “Pro-fax” by Basell, and having melt flow index values ranging from 18 to 35 and flex modulus values ranging from 150,000 to 200,000 psi; propylene copolymers sold by BP Amoco under the names Acclear® 8949 and Acctuf® impact copolymer 3934X, having melt flow index values of 35 and 100, and flex modulus values of 190,000 psi and 250,000 psi, respectively; resins sold by Dow Plastics under the names Inspire C703-35U and Inspire C719-35RN HP, both having a melt flow index of 35, and flex modulus values of 180,000 psi and 160,000 psi, respectively; Exxtral® BMT 106 polypropylene impact copolymer, sold by ExxonMobil Chemical, having a melt index of 8 and flex modulus of about 218,000 psi; and, long glass fiber reinforced polypropylenes sold by StaMax, resin 30YM240/10010 having a flex modulus of about 856,000 psi, and resin 40YM240/10010 having a flex modulus of about 1,140,000 psi. With long glass fiber reinforced polypropylenes having very high flex modulus values, it is believed that the glass fibers do not migrate into the hook cavities of the mold, so that the integrally molded hooks are made up of only the polypropylene component of the resin. This gives the unexpected result of a field of flexible hooks integrally molded on a surface of a very strong, rigid molded object.

Resins other than propylene based resins also can be suitable for use in the manufacture of the molded integral hooks of the present invention. Such resins can include high impact polystyrene, acrylonitrile-butadiene-styrene, nylon, high density polyethylene, linear low density polyethylene, polycarbonate, and thermoplastic olefin resins. Melt index has been found to range from 1 to 100, and flex modulus values values have been found to range from under 30,000 to over 1,138,000. The melt index values and flex modulus values that will work depend on the particular resin chosen. Specific resins include high impact polystyrene API 550 from American Polymers, having a melt flow index of 8 and a flex modulus of 280,000 psi; acrylonitrile-butadiene-styrene, including ABS 9501 UHI from Diamond Polymers, having a melt flow index of 1 and a flex modulus of about 295,000 psi, and Starex ABS SD-0150, sold by Samsung, and having a flex modulus of 420,000 psi; nylon, including Akulon® K224-PG2U Nylon 6, sold by DSM Engineering and having a flex modulus of about 580,000 psi, and Celanese nylon 6/6 1000 sold by Ticona, and having a flex modulus of about 420,000; high density polyethylene Alathon® H 5618, sold by Equistar Chemicals having a melt flow index of 18; linear low density polyethylene Petrothene® GA 564-000 sold by Equistar Chemicals and having a melt flow index of 21; polycarbonate Lexan ML4991R sold by General Electric, having a melt flow index of about 300,000; and thermoplastic olefin polymer Ecobarrier 1B00-2614 TP, having a melt index of 4 and a flex modulus of about 26,000. For polymers having such low flex modulus values, it may be necessary or desirable to use a thicker hook shape to provide a hook that is stiff enough and strong enough to provide the desired closure properties.

As further disclosed in the aforementioned patents U.S. Pat. No. 5,368,549, U.S. Pat. No. 5,656,226, and U.S. Re. No. 37,338, an apparatus for making the injection molded mold inserts comprises a mold for forming the mold insert 10, the mold having a recess in at least one predetermined area thereof, and means in the recess for simultaneously and integrally forming a field of injection molded hooks during the injection molding of the insert. The field of hooks has a length and a width, the hooks being interspersed in both the length and width of the field. The means in the recess for forming the hooks has a plurality of hook shaped cavities. The means is in unitary assembly during the injection molding of the insert, and is maintained in unitary assembly during the removal of the injection molded insert therefrom. In a preferred embodiment, the means in the recess for forming the hooks during the injection molding process is an assembly of stacked plates, each plate having a plurality of hook shaped cavities formed in one edge thereof. In a most preferred embodiment, the plates having the hook shaped cavities alternate in the stack with plates called spacers, which have no hook shaped cavities. The spacer plates can have width less than, equal to, or greater than the plates with the hook shaped cavities.

While the mold inserts 10, 110, and 210 illustrated in FIGS. 1, 3, and 5, respectively have been illustrated in which the fastening elements 18, 118, and 218 all have been in the form of injection molded hooks, the invention is not so limited. The fastening elements also can be in the form of mushroom shaped fastening elements, palm tree shaped fastening elements, or cane shaped hooks but either stiffer or of a different shape than those described in the aforementioned U.S. Pat. No. 5,368,549, U.S. Pat. No. 5,656,226, and U.S. Re. No. 37,338. In such embodiments, the means for forming the field of fastening elements may require the use of plates that move with respect to one another during the unmolding of the insert 10 to avoid breaking the fastening elements.

The mold inserts made in accordance with the invention can be used in any molding process in which the mold cavity can be adapted to accommodate the insert. Such molding processes include, by way of example and not by way of limitation, injection molding, compression molding, rotational molding, blow molding, foam molding and other known molding techniques. The instant invention is also applicable to molding processes in which a molding material is dispersed inside a mold be means such as a spray gun or a trowel, as in the manufacture of epoxy-based or fiberglass articles, such as fiberglass boat hulls.

The foregoing specification describes only the embodiment of the invention shown and/or described. Other embodiments may be articulated as well. The terms and expressions used, therefore, serve only to describe the invention by example and not to limit the invention. It is expected that others will perceive differences which, while different from the foregoing, do not depart from the scope of the invention herein described and claimed. In particular, any of the specific constructional elements described may be replaced by any other known element having equivalent function.

What is claimed is:

1. An injection molded insert for use as a component of a molded article made from a molten plastic, said insert comprising
a substantially rigid wall member, said substantially rigid wall member having opposed first and second surfaces, said first surface having a field of integrally molded hooks formed on at least a portion thereof, and
means for engaging molten plastic during the manufacture of the molded article from molten plastic, such that the molten plastic can flow around and be engaged by said engaging means during the manufacture of the molded article, such that said insert becomes a component of said molded article with said field of integrally molded hooks on a surface of said molded article.

2. The injection molded insert of claim 1 wherein said engaging means comprises a portion of said wall member extending beyond said field of hooks, said extending wall portion comprising means for receiving molten plastic.

3. The insert of claim 2 wherein said means for receiving molten plastic comprises a plurality of orifices in said extending wall portion, such that molten plastic can flow into said orifices from said second surface of said extending wall portion to said first surface of said extending wall portion to engage said wall portion.

4. The insert of claim 2 wherein said receiving means comprises a plurality of grooves on at least said first surface of said extending wall portion, such that molten plastic can flow into said grooves to engage said extending wall portion.

5. The insert of claim 1 wherein said engaging means comprises at least one projection extending from said wall member, such that molten plastic can flow around and be engaged by said at least one projection.

6. The injection molded insert of claim 1 further comprising an integrally formed injection molded ridge surrounding said field of integrally formed hooks.

7. The injection molded insert of claim 1 wherein said first surface comprises a plateau and said field of integrally formed hooks is formed on said plateau.

8. The injection molded insert of claim 1 wherein said insert is made from a material selected from the group consisting of polypropylene, polypropylene copolymer, glass filled polypropylene, high impact polystyrene, acrylonitrite-butadiene-styrene, nylon, high density polyethylene, linear low density polyethylene, polycarbonate, and thermoplastic olefin polymer.

9. A method of making a molded article from a molten plastic, the molded article having an integral field of molded hooks, comprising
providing an injection molded insert for use as a component of the molded article, said insert comprising a substantially rigid wall member, said substantially rigid wall member having opposed first and second surfaces, said first surface having a field of integrally molded hooks formed on at least a portion thereof, and said insert having means for engaging molten plastic during the molding of the molded article, such that the molten plastic can flow around and be engaged by said engaging means,
positioning said injection molded insert in a mold such that said field of integrally formed hooks is at a position corresponding to the desired location of the field of hooks on the finished molded article, and
adding molten plastic to said mold in accordance with a molding technique such that said molten plastic flows around and engages said engaging means, and such that said insert becomes a component of said molded article with said field of integrally molded hooks on a surface of said molded article.

10. The method of claim 9 wherein said molding technique is selected from the group consisting of injection molding, compression molding, rotational molding, and blow molding.

11. The method of claim 9 wherein said insert is made from a material selected from the group consisting of polypropylene, polypropylene copolymer, glass filled polypropylene, high impact polystyrene, acrylonitrite-butadiene-styrene, nylon, high density polyethylene, linear low density polyethylene, polycarbonate, and thermoplastic olefin polymer.

12. The method of claim 9 wherein said mold includes a recess for receiving said insert and said insert is positioned in said mold within said recess.

13. A method of making a molded article from a moldable mass, the molded article having an integral field of molded hooks, comprising
providing an injection molded insert for use as a component of the molded article, said insert comprising a substantially rigid wall member, said substantially rigid wall member having opposed first and second surfaces, said first surface having a field of integrally molded hooks formed on at least a portion thereof, and said insert having means for engaging a moldable mass during the molding of the molded article, such that the moldable plastic can flow around and be engaged by said engaging means,
positioning said injection molded insert in a mold such that said field of integrally formed hooks is at a position corresponding to the desired location of the field of hooks on the finished molded article,
adding the moldable mass to said mold such that said moldable mass flows around and engages said engaging means, and such that said insert becomes a component of said molded article with said field of integrally molded hooks on a surface of said molded article.

14. The method of claim 13 wherein said moldable mass is selected from the group consisting of sprayable resins, epoxy-based resins, and fiberglass-based resins.

15. The method of claim 14 wherein said moldable mass is applied by spraying.

16. The method of claim 14 wherein said moldable mass is applied by spreading.

17. The method of claim 13 wherein said insert is made from a material selected from the group consisting of polypropylene, polypropylene copolymer, glass filled polypropylene, high impact polystyrene, acrylonitrite-butadiene-styrene, nylon, high density polyethylene, linear low density polyethylene, polycarbonate, and thermoplastic olefin polymer.

18. The method of claim 13 wherein said mold includes a recess for receiving said insert and said insert is positioned in said mold within said recess.

19. A molded article made from a moldable plastic, said molded article having an injection molded insert as a component thereof, said injection molded insert comprising a substantially rigid wall member, said substantially rigid wall member having opposed first and second surfaces, said first surface having a field of integrally molded hooks formed on at least a portion thereof, and said insert having means for engaging moldable plastic during the molding of the molded article, such that the moldable plastic can flow around and be engaged by said engaging means, said field of molded hooks being integral with a surface of said molded article.

20. The molded article of claim 16, said molded article being selected from the group consisting of an injection molded article, a compression molded article, a rotational molded article, and a blow molded article.

21. The molded article of claim 19 wherein said injection molded insert comprises an integrally formed injection molded ridge surrounding said field of integrally formed hooks.

22. The molded article of claim 19 wherein said first surface comprises a plateau and said field of integrally formed hooks is formed on said plateau.

23. The molded article of claim 19 wherein said insert is made from a material selected from the group consisting of polypropylene, polypropylene copolymer, glass filled polypropylene, high impact polystyrene, acrylonitrite-butadiene-styrene, nylon, high density polyethylene, linear low density polyethylene, polycarbonate, and thermoplastic olefin polymer.

24. The molded article of claim 19 wherein said moldable plastic is selected from the group consisting of sprayable resins, epoxy-based resins, and fiberglass-based resins.
